(19) United States
(12) Patent Application Publication
(10) Pub. No.: US 2024/0003166 A1
(43) Pub. Date: Jan. 4, 2024

(54) LOCK TONGUE DEVICE

(71) Applicant: ZHONGSHAN CITY JIAHU HARDWARE PRODUCTS CO.,LTD., Zhongshan (CN)

(72) Inventors: YEBIAO WEN, Zhongshan (CN); IVAN HE, Zhongshan (CN)

(21) Appl. No.: 18/180,790

(22) Filed: Mar. 8, 2023

Related U.S. Application Data
(63) Continuation of application No. PCT/CN2022/106837, filed on Jul. 20, 2022.

(30) Foreign Application Priority Data
Jun. 29, 2022 (CN) 202210752530.6

(51) Int. Cl. E05B 63/06

(52) U.S. Cl. CPC E05B 63/06

(57) ABSTRACT

A lock tongue device, comprises an adjustment structure and a lock core structure, the adjustment structure comprises an outer shell, the lock core structure comprises an inner shell and a lock tongue assembly, and the lock tongue assembly protrudes from an end of the inner shell away from the adjustment structure, the inner shell is penetrated inside the outer shell and can move along the length direction of the outer shell, and an elastic protruding point is formed on the outer wall of the inner shell, a first locking hole and a second locking hole are arranged on the outer shell along the length of the lock tongue device; the overall length of the lock tongue device can be adjusted by the elastic protruding point being clamped in the first locking hole or the second locking hole, which has good practicability.

### CROSS-REFERENCE TO RELATED APPLICATIONS

The present application is a U. S. continuation of co-pending International Patent Application No. PCT/CN2022/106837 filed Jul. 20, 2022, which claims foreign priority of Chinese Patent Application No. 202210752530.6, filed on Jun. 29, 2021 in the State Intellectual Property Office of China, the contents of all of which are hereby incorporated by reference.

### TECHNICAL FIELD

The present disclosure relates to the technical filed of lock tongue, and in particular to a lock tongue device.

### BACKGROUND

Because the length of the existing lock tongue device cannot be adjusted, in different usage scenarios, due to the inconsistent length of the required lock tongue device, it is necessary to produce lock tongue devices of different lengths to meet different requirements, which increases the complexity of production.

### SUMMARY

The present disclosure solves one of the problems existing in the related art to a certain extent. Therefore, the purpose of the present disclosure is to provide a deadbolt device whose overall length can be adjusted.

The above-mentioned purpose is achieved through the following technical solutions:

A lock tongue device, comprising an adjustment structure and a lock core structure, the adjustment structure comprises an outer shell, the lock core structure comprises an inner shell and a lock tongue assembly, and the lock tongue assembly protrudes from an end of the inner shell away from the adjustment structure, the inner shell is penetrated inside the outer shell and can move along the length direction of the outer shell, and an elastic protruding point is formed on the outer wall of the inner shell, a first locking hole and a second locking hole are arranged on the outer shell along the length of the lock tongue device; the length of the lock tongue device is adjusted by engaging the elastic protruding point with the first locking hole or the second locking hole respectively, a limit passing groove is communicated between the first locking hole and the second locking hole, and when the elastic protruding point extends into the locking hole in place, it is hindered by the locking hole and cannot pass through the limit passing groove to reach another locking hole, when the elastic protruding point extends into the locking hole and is not in place, it can pass through the limit passing groove to reach another locking hole.

As a further improvement of the present disclosure, the elastic protruding point comprises a lower bump body and an upper bump body connected together, an outer contour of the upper bump body is relatively small so as to pass through the limit passing groove, an outer contour of the lower bump body is relatively large so that it cannot pass through the limit passing groove, when the elastic protruding point extends into the locking hole and is in place, the lower body of the protruding point is hindered by the locking hole and cannot pass through the limit passing groove to reach another locking hole, when the elastic protruding point extends into the locking hole and is not in place, the lower body of the protruding point is separated from the locking hole so that the upper body of the protruding point can pass through the limit passing groove to reach another locking hole.

As a further improvement of the present disclosure, the adjustment structure comprises a main shell, the main shell is connected with the outer shell, and a transmission plate is arranged on the lock core structure, and the transmission plate protrudes from the lock core structure toward the main shell, and an engaging structure is arranged inside the main shell, and the position of the adjusting structure and the lock core structure is locked by engaging the engaging structure with an engaging groove on the transmission plate.

As a further improvement of the present disclosure, a chute is formed at the inner shell, and the transmission plate and one end arranged on the lock core structure are installed in the chute so as to slide left and right, and a bump is arranged on the transmission plate, so that the bump is used to limit the transmission plate from detaching from the chute.

As a further improvement of the present disclosure, a plectrum is arranged on the inner shell, and the middle part of the plectrum forms a connection point, and the plectrum is rotatably installed in the inner shell by the connection point, and an contact point is formed on one end of the plectrum closing to the transmission plate, and the contact point is in contact with the transmission plate, and the other end of the plectrum forms a first transmission point, and the first transmission point is connected with the lock tongue assembly.

As a further improvement of the present disclosure, the distance between the connection point and the contact point is L1, and the distance between the connection point and the first transmission point is L2, wherein L1 is smaller than L2.

As a further improvement of the present disclosure, a pick is arranged in the main shell, and the pick is set in cooperation with one end of the transmission plate extending into the main shell, so that the transmission plate can be driven to move left and right in the inner shell by the rotation of the pick.

As a further improvement of the present disclosure, also comprises a lock piece, the lock tongue assembly comprises a lock tongue body, one end of the lock piece is rotatably installed in the inner shell, and an abutment surface is formed at the lock tongue body, the other end of the lock piece abuts against the abutment surface, so as to limit the movement of the lock tongue body by the lock piece.

As a further improvement of the present disclosure, a second transmission point is formed on the plectrum, the second transmission point is used to drive the lock piece to rotate, and the second transmission point is between the contact point and the first transmission point.

As a further improvement of the present disclosure, an embedding hole is formed in the lock tongue body, and the embedding hole is next to the abutment surface, when the lock piece is rotated to extend into the embedding hole, the restriction of the lock piece on the movement of the deadbolt assembly is released.

Compared with the prior art, the present disclosure at least includes the following beneficial effects:

In this case, the outer shell moves relative to the inner shell, and the overall length of the lock tongue device can be adjusted by the elastic protruding point being clamped in the first locking hole or the second locking hole, which has good practicability. The limit passing groove between the first locking hole and the second locking hole is set so that when the elastic protruding point extends into the locking hole and is not in place, it can pass through the limit passing groove to reach another locking hole. After reaching the other locking hole, the elastic protruding point stretches into the locking hole under the action of elastic force and is hindered by the locking hole, so that the elastic protruding point stays in the locking hole, which is easy to operate and good in practicability.

### BRIEF DESCRIPTION OF DRAWINGS

FIG. 1 is a structure schematic diagram of a lock tongue according to an embodiment of the present disclosure.

FIG. 2 is another structure schematic diagram of a lock tongue according to an embodiment of the present disclosure.

FIG. 3 is a decomposition diagram of a lock tongue according to an embodiment of the present disclosure.

FIG. 4 is an internal structure schematic diagram of a lock tongue according to an embodiment of the present disclosure.

FIG. 5 is an explosion diagram of a lock tongue according to an embodiment of the present disclosure.

### DETAILED DESCRIPTION

The following examples illustrate the disclosure, but the disclosure is not limited by these examples. Modifications to the specific implementation of the present disclosure or equivalent replacement of some technical features without departing from the spirit of the present disclosure should be included in the scope of the technical solution claimed in the present disclosure.

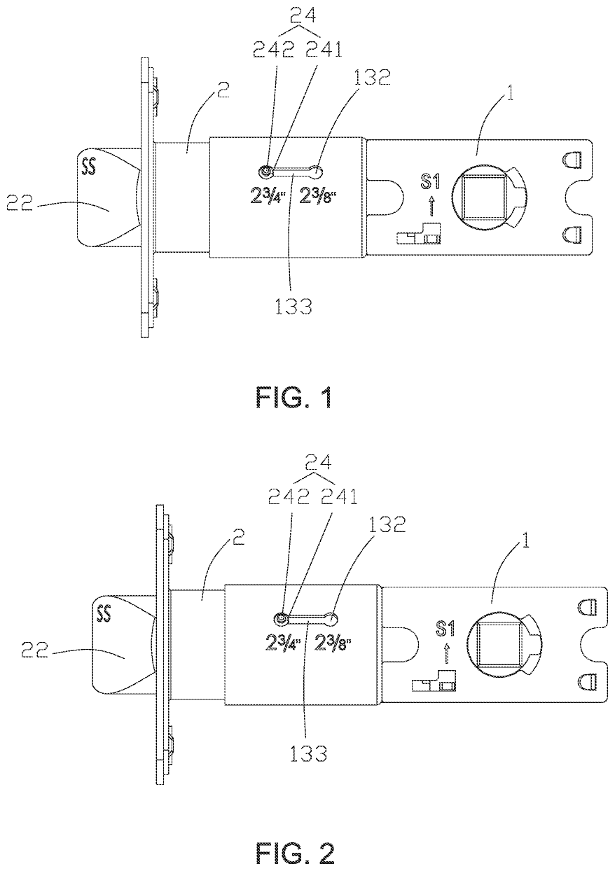

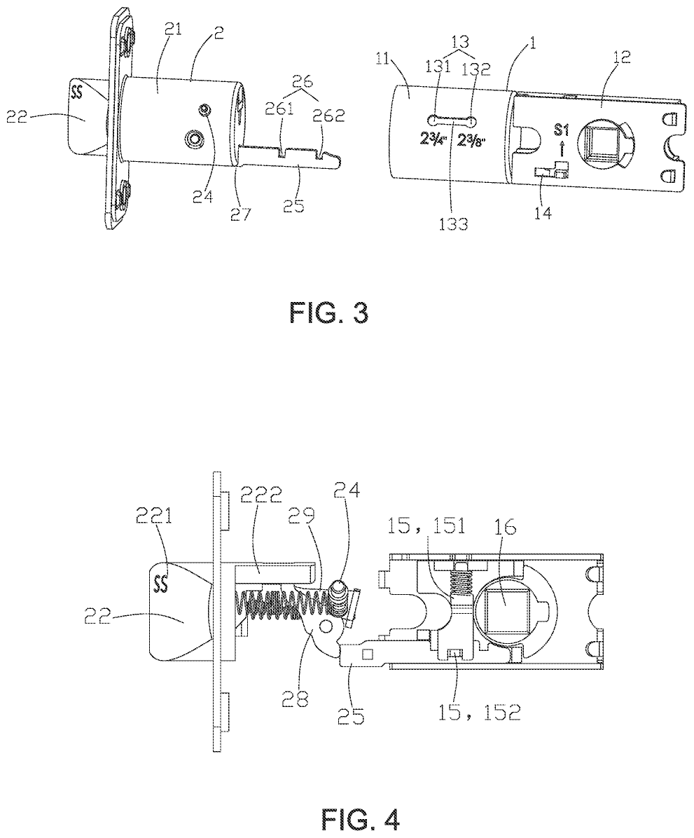

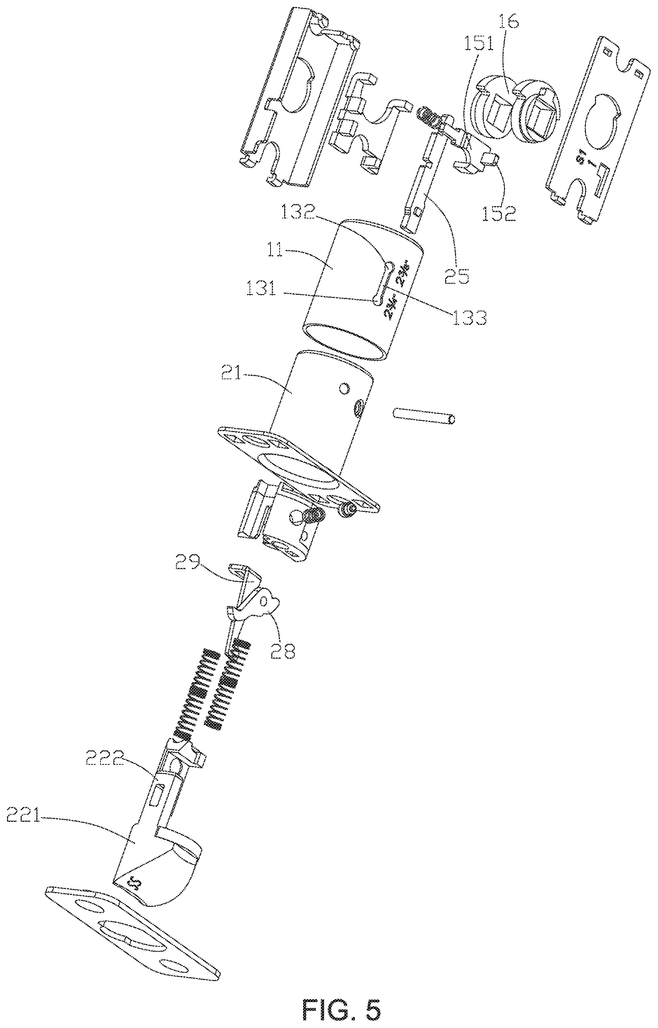

Refer to FIG. 1-5, A lock tongue device, comprises an adjustment structure 1 and a lock core structure 2, the adjustment structure 1 comprises an outer shell 11, the lock core structure 2 comprises an inner shell 21 and a lock tongue assembly 22, and the lock tongue assembly 22 protrudes from an end of the inner shell 21 away from the adjustment structure 1, the inner shell 21 is penetrated inside the outer shell 11 and can move along the length direction of the outer shell 11, and an elastic protruding point is formed on the outer wall of the inner shell 21, a first locking hole 131 and a second locking hole 132 are arranged on the outer shell 11 along the length of the lock tongue device; the length of the lock tongue device is adjusted by engaging the elastic protruding point 24 with the first locking hole 131 or the second locking hole 132 respectively, a limit passing groove 133 is communicated between the first locking hole 131 and the second locking hole 132, and when the elastic protruding point 24 extends into the locking hole in place, it is hindered by the locking hole and cannot pass through the limit passing groove 133 to reach another locking hole, when the elastic protruding point 24 extends into the locking hole and is not in place, it can pass through the limit passing groove to reach another locking hole.

As above, in this case, the outer shell 11 moves relative to the inner shell 21, and the overall length of the lock tongue device can be adjusted by the elastic protruding point 24 being clamped in the first locking hole 131 or the second locking hole 132, which has good practicability. The limit passing groove 133 between the first locking hole 131 and the second locking hole 132 is set so that when the elastic protruding point 24 extends into the locking hole and is not in place, it can pass through the limit passing groove 133 to reach another locking hole. After reaching the other locking hole, the elastic protruding point 24 stretches into the locking hole under the action of elastic force and is hindered by the locking hole, so that the elastic protruding point 24 stays in the locking hole, which is easy to operate and good in practicability.

In this embodiment, an opening cavity is formed in the outer shell 11 toward the direction of the lock core structure 2, so that the inner shell 21 can extend into the cavity of the outer shell 11 and can be inserted into the outer shell 11. Movement in the left-right direction relative to the outer shell 11 occurs in the cavity.

As mentioned above, in the specific implementation, the elastic protruding point 24 comprises a lower bump body 241 and an upper bump body 242 connected together, an outer contour of the upper bump body 242 is relatively small so as to pass through the limit passing groove 133, an outer contour of the lower bump body 241 is relatively large so that it cannot pass through the limit passing groove 133, when the elastic protruding point 24 extends into the locking hole and is in place, the lower body of the protruding point 241 is hindered by the locking hole and cannot pass through the limit passing groove 133 to reach another locking hole, when the elastic protruding point 24 extends into the locking hole and is not in place, the lower body of the protruding point 241 is separated from the locking hole so that the upper body of the protruding point 242 can pass through the limit passing groove to reach another locking hole. It is easy to implement.

As mentioned above, in practice, a spring can be used to drive the elastic protruding point 24 to elastically extend into the locking hole, and the user presses the upper bump body 242 to make the lower bump body 241 out of the locking hole.

In this embodiment, the length of the entire lock tongue device is 60 cm or 70 cm, and the distance between the first locking hole 131 and the second locking hole 132 is cm.

In this embodiment, the first locking hole 131 is set at one end close to the lock core structure 2, and the second locking hole 132 is set at the end far away from the lock core structure 2. When the overall length is adjusted to 60 cm, move the outer shell 11 toward the direction close to the lock core structure 2, so as to engage the elastic protrusion 24 with the second locking hole 132, as shown in FIG. 1. When the length is adjusted to cm, the outer shell 11 is moved away from the lock core structure 2 to engage the elastic protruding point 24 with the first locking hole 131, as shown in FIG. 2.

The adjustment structure 1 comprises a main shell 12, the main shell 12 is connected with the outer shell 11, and a transmission plate 25 is arranged on the lock core structure 2, and the transmission plate 25 protrudes from the lock core structure 2 toward the main shell 12, and an engaging structure 15 is arranged inside the main shell 12, and the position of the adjusting structure 1 and the lock core structure 2 is locked by engaging the engaging structure 15 with an engaging groove 26 on the transmission plate 25.

In this embodiment, one end of the main shell 12 facing the outer shell 11 is arranged with a buckle, and the end surface of the outer shell 11 facing the main shell 12 is arranged with a mounting hole, connect the housing 11 with the main housing 12 by connecting the buckle and the mounting hole.

The main shell 12 comprises a box body with an upward opening and an upper cover, the upper cover is arranged on the box body to form an installation cavity between the box body and the upper cover, the engaging structure 15 is arranged in the installation cavity.

In this embodiment, the transmission plate 25 is connected to the lock core structure 2. A perforation is arranged on the outer shell 11, and the transmission plate 25 protrudes toward the installation cavity of the main shell 12 through the perforation.

A sliding hole 14 is arranged at the upper cover, and the sliding hole 14 comprises a vertical hole arranged along the vertical direction. The engaging structure 15 comprises a body 151 and an adjusting block 152 extending upward from the body, and the adjusting block 152 protrudes from the sliding hole 14, so as to drive the engaging structure 15 to move when the adjusting block 152 moves up and down at the vertical hole. The adjusting block 152 engages with the slot 26 on the transmission plate 25.

Wherein, the locking groove 26 on the transmission plate 25 is adapted to the number of locking holes of the locking hole group 13. In this embodiment, the locking groove 26 includes a first locking slot 261 and a second locking slot 262, and the distance between the first locking slot 261 and the second locking slot 262 is the same as that of the first locking hole 131 and the second locking hole 132. In this embodiment, the distance between the first locking slot 261 and the second locking slot 262 is 10 cm.

The first locking slot 261 or the second locking slot 262 is clamped by the adjusting block 152, so as to limit the movement of the outer shell 11 toward or away from the lock core structure 2, so as to limit the length of the lock tongue device adjustment, the position between the adjustment structure 1 and the lock core structure 2 is relatively fixed; at this time, the transmission plate 25 can move left and right in the lateral direction, that is, the outer shell 11 can move toward or away from the lock core structure 2, so as to adjust the overall length of the lock tongue device.

Wherein, the sliding hole 14 also comprises a transverse hole, and the transverse hole communicates with the vertical hole.

In this embodiment, an elastic member is arranged at the body of the engaging structure 15, so that the adjusting block 152 of the engaging structure 15 always approaches the transmission plate 25.

A chute 27 is formed at the inner shell 21, and the transmission plate 25 and one end arranged on the lock core structure 2 are installed in the chute 27 so as to slide left and right, and a bump is arranged on the transmission plate 25, so that the bump is used to limit the transmission plate 25 from detaching from the chute 27.

In this embodiment, the height of the chute 27 is greater than the thickness of the transmission plate 25, so that the end of the transmission plate 25 close to the inner shell 21 can be slid left and right installed in the chute 27, A bump is provided on the transmission plate 25, and the overall height of the transmission plate 25 and the protrusion is greater than the height of the chute 27, so as to prevent the transmission plate 25 from breaking away from the chute 27 when moving left and right.

A plectrum 28 is arranged on the inner shell 21, and the middle part of the plectrum 28 forms a connection point, and the plectrum 28 is rotatably installed in the inner shell 21 by the connection point, and an contact point is formed on one end of the plectrum 28 closing to the transmission plate 25, and the contact point is in contact with the transmission plate 25, and the other end of the plectrum 28 forms a first transmission point, and the first transmission point is connected with the lock tongue assembly. When the transmission plate 25 moves towards the plectrum 28 to touch the plectrum 28 at the contact point, the plectrum 28 rotates clockwise at the connection point of the inner shell 21, and the rotation of the plectrum 28 can be passed through its first transmission point drives the lock tongue assembly 22 to shrink into the cavity of the inner shell 21 to realize unlocking.

The distance between the connection point and the contact point is L1, and the distance between the connection point and the first transmission point is L2, wherein L1 is smaller than L2.

A pick 16 is arranged in the main shell 12, and the pick 16 is set in cooperation with one end of the transmission plate 25 extending into the main shell 12, so that the transmission plate 25 can be driven to move left and right in the inner shell 21 by the rotation of the pick 16. When the pick 16 rotates clockwise or counterclockwise, it can drive the transmission plate 25 to move to the left, so as to trigger the plectrum 28 through the trigger point, so that the plectrum 28 rotates clockwise, the rotation of the plectrum 28 drives the lock tongue assembly 22 to shrink into the cavity of the inner shell 21 to realize unlocking. The distance L1 between the connection point and the contact point is smaller than the distance L2 between the connection point and the first transmission point, that is, the transmission plate 25 moves to the left a small distance to make the plectrum 28 rotate, and the lock tongue assembly 22 shrinks into the cavity of the inner shell 21 to realize the effect of unlocking, that is, the small angle of rotation of the pick 16 can make the lock tongue assembly 22 shrink into the cavity of the inner shell 21 to realize the effect of unlocking.

Also comprising a lock piece 29, the lock tongue assembly 22 comprises a lock tongue body 221, one end of the lock piece 29 is rotatably installed in the inner shell 21, and an abutment surface is formed at the lock tongue body 221, the other end of the lock piece 29 abuts against the abutment surface, so as to limit the movement of the lock tongue body 221 by the lock piece 29.

In this embodiment, the lock tongue assembly 22 comprises a lock tongue body 221 and a support arm 222 formed by extending the lock tongue body 221 toward the cavity of the inner shell 21, and a buckle is arranged on the support arm 222. One end of the first transmission point of the plectrum 28 is fastened with the fastening hole to link the lock tongue assembly 22.

One end of the lock piece 29 is connected to the cavity of the inner shell 21, and the other end abuts against the abutting surface of the lock tongue body 221 to limit the contraction of the lock tongue assembly 22 toward the cavity of the inner shell 21 to maintain the protruding state of the lock tongue assembly 22 maintains the locked state.

A second transmission point is formed on the plectrum 28, the second transmission point is used to drive the lock piece 29 to rotate, and the second transmission point is between the contact point and the first transmission point.

An embedding hole is formed in the lock tongue body 221, and the embedding hole is next to the abutment surface, when the lock piece 29 is rotated to extend into the embedding hole, the restriction of the lock piece 29 on the movement of the lock tongue assembly is released.

That is, when the plectrum 28 rotates, the second transmission point on the plectrum 28 can drive the lock piece 29 to rotate, so that the lock piece 29 abuts against the abutment surface of the lock tongue body 221 rotate to the opening of the insertion hole, when the first transmission point of the plectrum 28 drives the lock tongue assembly 22 to move toward the cavity of the inner shell 21, the lock piece 29 extends into the insertion hole In the process, the lock tongue assembly 22 can be smoothly moved toward the cavity of the inner shell 21, effectively releasing the restriction on the movement of the lock tongue assembly 22 by the lock piece 29, and realizing unlocking.

The above-mentioned preferred implementation mode should be regarded as an illustration of the implementation mode of the application scheme, and any technical deduction, replacement, improvement, etc. that are similar to, similar to, or based on this application scheme should be regarded as the scope of protection of this disclosure.

What is claimed is:

1. A lock tongue device, comprising: an adjustment structure and a lock core structure, the adjustment structure comprises an outer shell, the lock core structure comprises an inner shell and a lock tongue assembly, and the lock tongue assembly protrudes from an end of the inner shell away from the adjustment structure, the inner shell is penetrated inside the outer shell and can move along the length direction of the outer shell, and an elastic protruding point is formed on the outer wall of the inner shell, a first locking hole and a second locking hole are arranged on the outer shell along the length of the lock tongue device; the length of the lock tongue device is adjusted by engaging the elastic protruding point with the first locking hole or the second locking hole respectively, a limit passing groove is communicated between the first locking hole and the second locking hole, and when the elastic protruding point extends into the locking hole in place, it is hindered by the locking hole and cannot pass through the limit passing groove to reach another locking hole, when the elastic protruding point extends into the locking hole and is not in place, it can pass through the limit passing groove to reach another locking hole.

2. The lock tongue device according to claim 1, wherein the elastic protruding point comprises a lower bump body and an upper bump body connected together, an outer contour of the upper bump body is relatively small so as to pass through the limit passing groove, an outer contour of the lower bump body is relatively large so that it cannot pass through the limit passing groove, when the elastic protruding point extends into the locking hole and is in place, the lower body of the protruding point is hindered by the locking hole and cannot pass through the limit passing groove to reach another locking hole, when the elastic protruding point extends into the locking hole and is not in place, the lower body of the protruding point is separated from the locking hole so that the upper body of the protruding point can pass through the limit passing groove to reach another locking hole.

3. The lock tongue device according to claim 1, wherein the adjustment structure comprises a main shell, the main shell is connected with the outer shell, and a transmission plate is arranged on the lock core structure, and the transmission plate protrudes from the lock core structure toward the main shell, and an engaging structure is arranged inside the main shell, and the position of the adjusting structure and the lock core structure is locked by engaging the engaging structure with an engaging groove on the transmission plate.

4. The lock tongue device according to claim 3, wherein a chute is formed at the inner shell, and the transmission plate and one end arranged on the lock core structure are installed in the chute so as to slide left and right, and a bump is arranged on the transmission plate, so that the bump is used to limit the transmission plate from detaching from the chute.

5. The lock tongue device according to claim 4, wherein a plectrum is arranged on the inner shell, and the middle part of the plectrum forms a connection point, and the plectrum is rotatably installed in the inner shell by the connection point, and an contact point is formed on one end of the plectrum closing to the transmission plate, and the contact point is in contact with the transmission plate, and the other end of the plectrum forms a first transmission point, and the first transmission point is connected with the lock tongue assembly.

6. The lock tongue device according to claim 5, wherein the distance between the connection point and the contact point is L1, and the distance between the connection point and the first transmission point is L2, wherein L1 is smaller than L2.

7. The lock tongue device according to claim 3, wherein a pick is arranged in the main shell, and the pick is set in cooperation with one end of the transmission plate extending into the main shell, so that the transmission plate can be driven to move left and right in the inner shell by the rotation of the pick.

8. The lock tongue device according to claim 5, wherein also comprises a lock piece, the lock tongue assembly comprises a lock tongue body, one end of the lock piece is rotatably installed in the inner shell, and an abutment surface is formed at the lock tongue body, the other end of the lock piece abuts against the abutment surface, so as to limit the movement of the lock tongue body by the lock piece.

9. The lock tongue device according to claim 8, wherein a second transmission point is formed on the plectrum, the second transmission point is used to drive the lock piece to rotate, and the second transmission point is between the contact point and the first transmission point.

10. The lock tongue device according to claim 8, wherein an embedding hole is formed in the lock tongue body, and the embedding hole is next to the abutment surface, when the lock piece is rotated to extend into the embedding hole, the restriction of the lock piece on the movement of the lock tongue assembly is released.
